(19) United States
(12) Patent Application Publication
(10) Pub. No.: US 2025/0147824 A1
(43) Pub. Date: May 8, 2025

(54) SYSTEM AND METHOD FOR AMBIENT AWARENESS WITHIN A WEB ENVIRONMENT

(71) Applicant: American Express Travel related Services Company, Inc., New York, NY (US)

(72) Inventors: Rick BALLMAN, Phoenix, AZ (US); Shanmuga KRISHNAMURTHY, Phoenix, AZ (US)

(73) Assignee: American Express Travel related Services Company, Inc., New York, NY (US)

(21) Appl. No.: 18/502,739

(22) Filed: Nov. 6, 2023

(51) Int. Cl. G06F 9/54; G06F 9/451

(52) U.S. Cl. CPC G06F 9/542; G06F 9/451

(57) ABSTRACT

Disclosed herein are system, method, and computer program product embodiments for providing ambient awareness of user actions between individual web modules or web applications within a webpage or web interface. The different modules subscribe to various notifications based on module type, action type, or other user action properties. An ambient awareness layer exists in the backend to receive detected event notifications from the different web modules indicating the detection of some user action with respect to graphical user interfaces (GUIs) generated by those modules. Based on the subscription properties, the ambient awareness layer identifies one or more web modules to be notified of the detected event. The ambient awareness layer then transmits an event notification to those modules. In response, the modules that receive the notification can modify the appearance of respective GUIs or their behavior to specifically tailor themselves to the user's actions or apparent interests.

### BACKGROUND

### Field

This field is generally related to software development and more specifically, to providing ambient awareness between independent web elements.

### Background

Web applications, specifically those provided in a web interface, are often developed independently of one another and are compiled into a web site for viewing by a user. These applications, due to their independent nature, are often static relative to each other. In other words, a user's activity within one web application generally does not affect or change the characteristics of another, nor does it change the user experience generally.

### BRIEF SUMMARY

Disclosed herein are system, apparatus, device, method and/or computer program product embodiments, and/or combinations and sub-combinations thereof, for providing ambient awareness between web applications (e.g., modules) within a web interface.

Web applications, specifically those provided in a web interface, are often developed independently of one another and are compiled into a web site for viewing by a user. These applications, due to their independent nature, are often static relative to each other. In other words, a user's activity within one web application generally does not affect or change the characteristics of another, nor does it change the user experience generally.

To provide more context, a webpage or website is often compiled of several different modules. In many development situations, and particularly those of large companies, these different modules are often developed by different teams of people and/or are developed specifically to be independent of each other. For example, there may be a marketing module designed to inform a customer of new products and/or services, an account module that provides the user with details of their account, a customer service module that allows the user to request or interact with a customer service agent, etc. For ease of development and implementation, these modules are not programmed to talk with one another, and therefore do not change in any way based on the activities of the user in any of the other modules. Specifically, coordinating between the different modules would not only require extensive additional coding, but would also require coordination between development teams. This makes for a relatively static website that is not capable of adjusting to the user's activity.

The present application provides solutions to this problem. According to the present application, an ambient awareness layer resides in the background of a webpage. The ambient awareness layer receives activity indicators from the various web modules and publishes this information to the other web modules and/or to the webpage manager. The web modules may then modify their behavior and/or appearance based on the provided information. Similarly, the webpage can adjust its layout and/or enable or disable different web modules.

In addition to receiving the activity messages from the various web modules, the ambient awareness can also receive inputs from external sources that may be relevant to the modules and/or web manager.

In this manner, a dynamic webpage is provided that can self-modify based on user activity and/or external factors. This not only greatly enhances user experience by providing a personalized experience, but does so in a way that does not significantly increase development time and costs. These and other advantages will be apparent from the following detailed description.

### BRIEF DESCRIPTION OF THE DRAWINGS

The accompanying drawings are incorporated herein and form a part of the specification.

FIG. 1 illustrates a block diagram of an ambient awareness environment, according to some embodiments.

FIG. 2 illustrates a block diagram of an exemplary web site layout, according to some embodiments.

FIG. 3 illustrates a block diagram of an ambient awareness system, according to some embodiments.

FIG. 4 illustrates a block diagram of an exemplary ambient awareness system, according to some embodiments.

FIG. 5 illustrates a flowchart diagram of an exemplary method for ambient awareness, according to some embodiments.

FIG. 6 illustrates a process flow diagram of an exemplary process for ambient awareness, according to some embodiments.

FIG. 7 depicts an example computer system useful for implementing various embodiments.

In the drawings, like reference numbers generally indicate identical or similar elements. Additionally, generally, the left-most digit(s) of a reference number identifies the drawing in which the reference number first appears.

### DETAILED DESCRIPTION

Disclosed herein are system, apparatus, device, method and/or computer program product embodiments, and/or combinations and sub-combinations thereof, for providing ambient awareness between web applications (e.g., modules) within a web interface. As will be used herein, a web module is one or more web applications having a corresponding display interface. The web applications support processes carried out by one or more processors that are responsive to user interactions within the display interface.

Web applications, specifically those provided in a web interface, are often developed independently of one another and are compiled into a web site for viewing by a user. These applications, due to their independent nature, are often static relative to each other. In other words, a user's activity within one web application generally does not affect or change the characteristics of another, nor does it change the web interface generally.

To provide more context, a webpage or website is often compiled of several different modules. In many development situations, and particularly those of large companies, these different modules are often developed by different teams of people and/or are developed specifically to be independent of each other. For example, there may be a marketing module designed to inform a customer of new products and/or services, an account module that provides the user with details of their account, a customer service module that allows the user to request or interact with a customer service agent, etc. For ease of development and implementation, these modules are not programmed to talk with one another, and therefore do not change in any way based on the activities of the user in any of the other modules. Specifically, coordinating between the different modules would not only require extensive additional coding, but would also require coordination between development teams. This makes for a relatively static website that is not capable of adjusting to the user's activity.

The present application provides solutions to this problem. According to the present application, an ambient awareness application resides in the background of a webpage. The ambient awareness application receives activity indicators from the various web modules and/or web applications and publishes this information to the other web modules, web applications, and/or to the webpage manager. The web modules and/or web applications may then modify their behavior and/or appearance based on the provided information. Similarly, the web manager can adjust the layout of the webpage and/or enable or disable different web modules and/or web applications.

In addition to receiving the activity messages from the various web modules and/or web applications, the ambient awareness can also receive inputs from external sources that may be relevant to the modules and/or web manager.

In this manner, a dynamic webpage is provided that can self-modify based on user activity and/or external factors. This not only greatly enhances user experience by providing a personalized experience, but does so in a way that does not significantly increase development time and costs.

Various embodiments of these features will now be discussed with respect to the corresponding figures. As discussed herein, the term “web module” may refer to one or more web applications having a corresponding display interface.

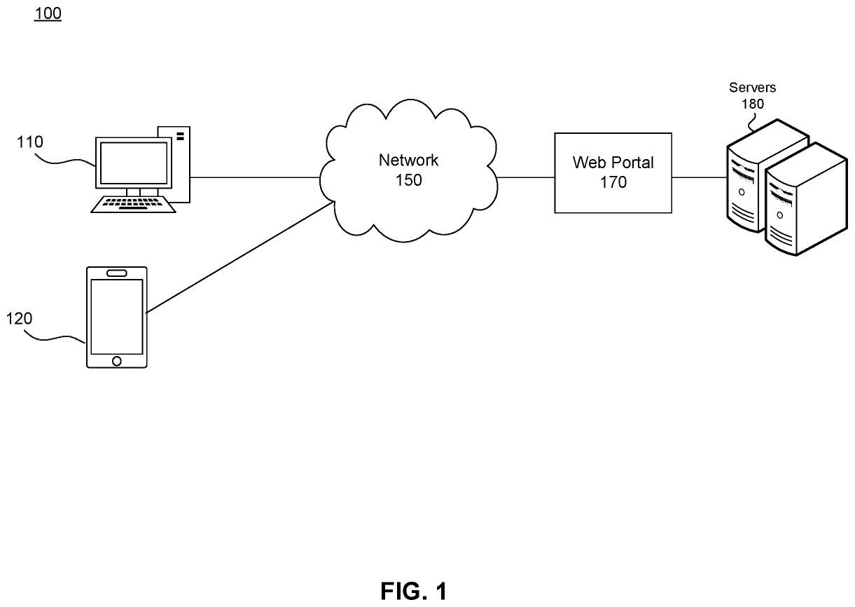

FIG. 1 illustrates a block diagram of an ambient awareness environment 100, according to some embodiments. As shown in FIG. 1, one or more user devices 110 or 120 may communicate with a web portal 170 via a network 150. The user devices 110 and 120 may include any suitable device capable of viewing and/or interacting with a website, including but not limited to a personal computer, a smartphone, a personal digital assistant, etc. The network 150 may be any suitable network capable of facilitating communication between the user devices 110 and 120 and the web portal 170, including but not limiting to the Internet, 3G, 4G, 5G, WAN, LAN, metropolitan area network, POTS network, and PSTN, among others, or any combination thereof.

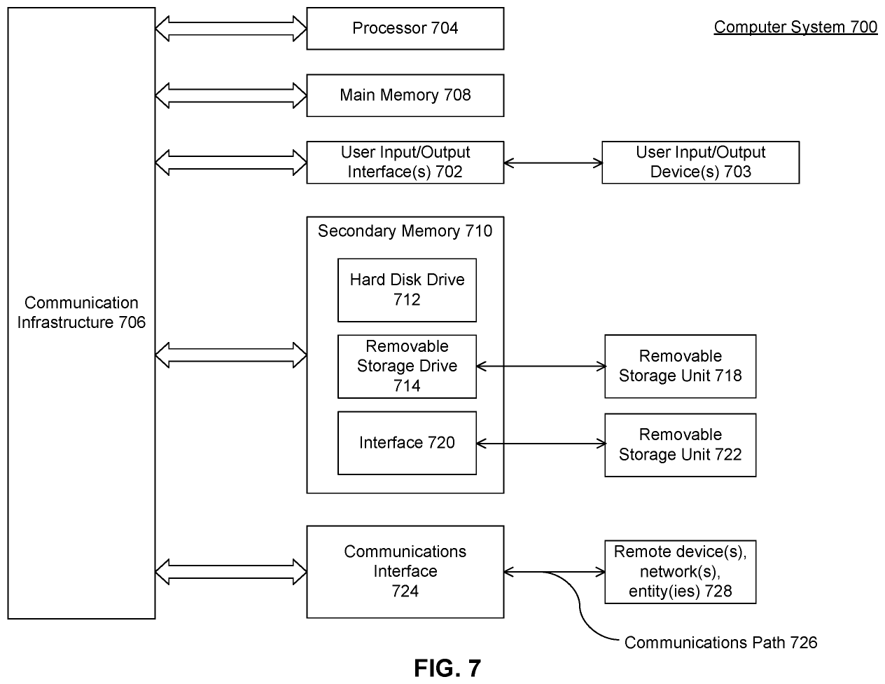

The web portal 170 provides web page or website to the user for viewing and interaction. The web portal 170 may be located at a web address accessible via a web browser, and may be supported by one or more backend servers 180 and/or computer system 700 as further described with reference to FIG. 7. In some instances, the web portal 170 is hosted on one or more servers 180. Together, the web portal 170 and the servers 180 provide the web pages and/or website to the user.

In operation, the user uses one of the user devices 110 or 120 and types a web address of the web page into a web browser running on the device. The browser communicates with the network 150, which navigates to and provides a connection to the web portal 170. The web portal 170 instantiates the requested web site for the user and, through the connection with the user device 110 or 120, provides the web page to the user for viewing and/or interaction. Some interactions by the user with the web page will cause web portal 170 to communicate with the servers 180 in order to fulfill requests, retrieve data, modify presentation, and/or populate related pages requested by the user.

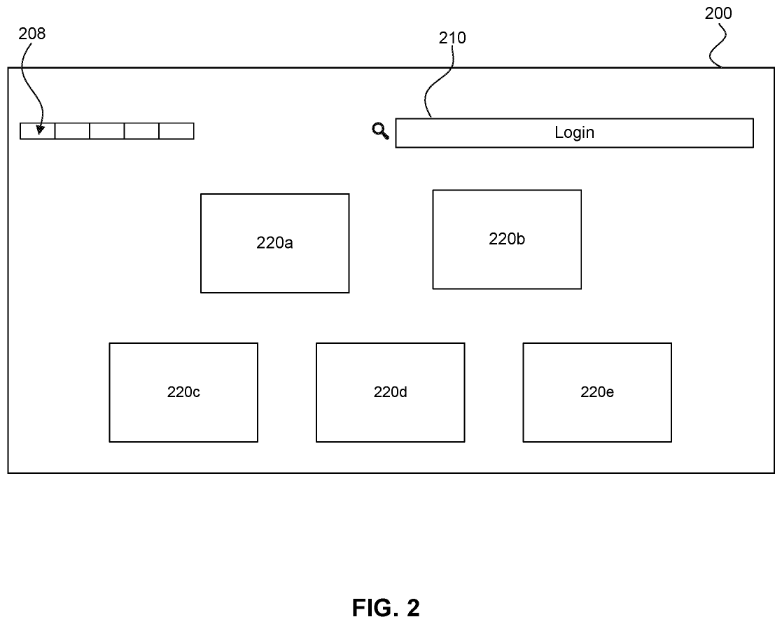

FIG. 2 illustrates a block diagram of an exemplary website 200, according to some embodiments. Website 200 may be a graphical user interface (GUI) generated by web portal 170 as described with reference to FIG. 1. As shown in FIG. 2, the exemplary website 200 includes several different sections, each of which may have multiple different modules. For example, in a header portion of the website 200, a plurality of category buttons 208 are provided. The category buttons 208 may function as tabs to quickly navigate between categories or preset webpages within the website. In an embodiment, the category buttons may comprise a web module.

Also within the header area of the website may be auxiliary buttons 210. In an embodiment, the auxiliary buttons includes such buttons as a “search” button, a “login” button, a “settings” button, and other similar buttons. In an embodiment, the auxiliary buttons also comprise a web module.

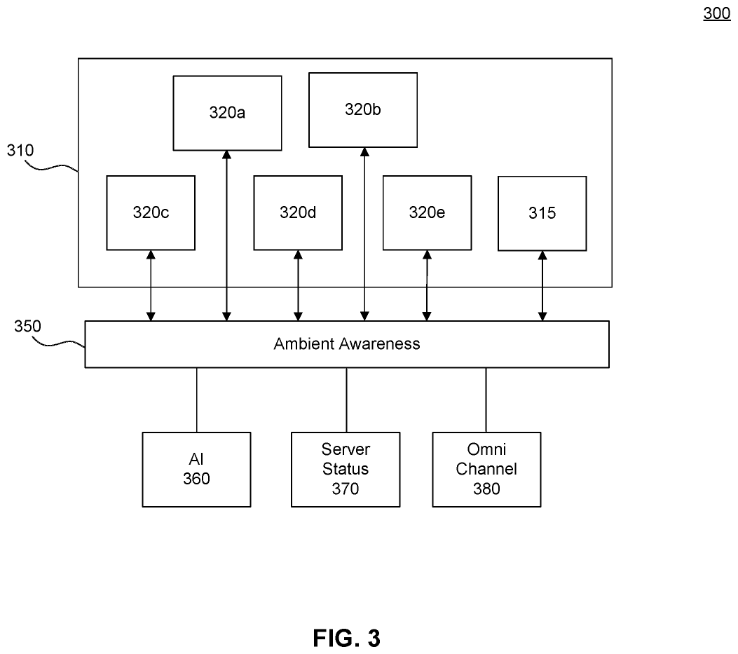

In an embodiment, the web page also includes a viewing area that includes several web graphical user interfaces (GUIs) 220a-220e corresponding to respective web modules. The web modules, as further described with reference to FIG. 3, generate respective web GUIs 220a-220e for display on website 200. Users may interact with the web GUIs 220a-220e to access the functionality and/or manipulate the data provided by the respective web modules. In an embodiment, each web GUI 220 is an independent visual block that appears within the web interface as a tile, link, window, or other entity that can be interacted with by the user. In an embodiment, each web GUI 220 is further represented by an independent block of web code. The web code may correspond to the web modules described with reference to FIG. 3. A web manager (not shown) compiles the website from the various code blocks associated with the different web modules in order to generate the web GUIs 220 and the website 200.

As described above, in typical web development, these different web GUIs 220 and/or their respective web modules may not be capable of communicating with each other, and may not be capable of adjusting their behavior or presentation based on the activities of the user within any of the other web modules or web GUIs 220. However, the present application solves this, as shown in FIG. 3.

FIG. 3 illustrates a block diagram of an ambient awareness system 300, according to some embodiments. As shown in FIG. 3, the ambient awareness system 300 includes a module portion 310 that includes the various web modules 320a-320e running within the web interface. In an embodiment, the web modules 320a-320e correspond to and/or generate web GUIs 220a-220e, respectively. In an embodiment, the module portion also includes a web manager 315 capable of controlling the layout and/or configuration of the web page.

An ambient awareness layer 350 is in communication with the various web modules 320, and is configured to receive event notifications from those web modules 320 and to transmit event notifications to the web modules 320. The ambient awareness module 350 may also receive stimuli from external sources. The event notifications received from the various modules 320 may indicate that the user has taken certain actions, supplied certain interactions, and/or provided activity with respect to content provided by those web modules 320. For example, web module 320a may correspond to an account module. Module 320a may detect that the user has moused over or clicked on a particular link. Module 320a may also determine that it has displayed certain information. The interaction and/or display information is then transmitted to the ambient awareness module 350.

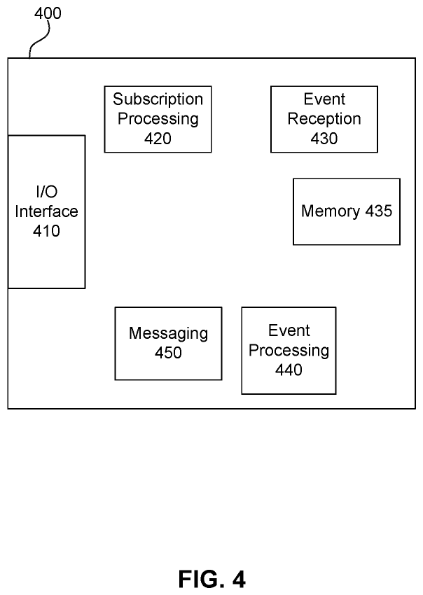

The ambient awareness layer 350 receives the event from the web module 320, and then performs an analysis to determine whether the event is relevant to any other of the various web modules 320, which is described in further detail below with respect to FIG. 4. If the ambient awareness module 350 determines the event to be relevant to another of the web modules 320, then the ambient awareness module 350 transmits a notification to that web module 320.

For example, a first module 320a may generate a web GUI that displays different credit cards with corresponding balances. A second module 320b may be an account module that provides account information in a separate web GUI. The user may click on a particular GUI object displayed by the first module 320a. The selected GUI object may correspond to a particular credit card. In response to the selection, the first module 320a may provide a notification of the click to ambient awareness module 350. Ambient awareness module 350 may then determine that second module 320b is subscribed to receive event notifications from such an interaction. Ambient awareness module 350 may then transmit a notification of the interaction to second module 320b. Second module 320b may then alter its corresponding web GUI to display recent transactions related to the card selected within the first module 320a.

In an embodiment, the ambient awareness module 350 can also perform this analysis based on external inputs. As shown in FIG. 3, such external inputs may include an Artificial Intelligence (AI) 360 input, a server status 370 input, and an omni-channel 380 input. In an embodiment, the AI 360 performs a wide variety of intelligent operations to make additional determinations as to relevant external events. For example, the AI 360 may monitor customer behavior, customer interactions, external events (such as weather, political events, news reports, etc.), and other data. Based on this information, the AI 360, which includes a machine-learning algorithm capable of taking in numerous inputs and executing an algorithm to determine events that would be relevant to the web modules 320 or the web manager 315. To provide an example, the AI 360 may determine from customer behavior that the customer visits the website on the 15^{th} of each month to pay their bill. As a result, when the AI 360 detects access to the website by the customer on or around the 15^{th}, the AI 360 may determine that the customer is likely to be visiting the website to pay their bill. Consequently, the AI 360 transmits an event notification message to relevant web modules 320 and/or web manager 315 to allow them to act on the information accordingly. For example, the web manager 315 may configure the website to move the web GUI corresponding to account module 320 to a pronounced position, or the web module 320 can modify its web GUI display to output a bill payment field or link.

A server status 370 may also provide external stimuli to the ambient awareness layer 350. In an embodiment, the server status 370 monitors the status of the server(s) hosting the webpage and provides certain information to the ambient awareness layer 350 regarding those statuses. Such statuses may include server latency, server load, network bandwidth between client device and server, and/or other performance metrics. Based on these inputs, the ambient awareness layer 350 determines whether the information is relevant to any of the web modules 320 or web manager 315, and generates notifications to any deemed interested. For example, certain large data functions implemented in the website may be rendered by the server rather than the user's browser to improve performance. However, high server latency or load may greatly increase the amount of time needed to run these functions. As such, the ambient awareness layer 350 may send a notification regarding server performance to the web modules 320 that carry out such large data functions.

Additionally, the ambient awareness layer 350 may receive event notifications from the omni-channel 380. The omni-channel 380 monitors the user's activity on other devices and/or related web pages. For example, the user may have multiple windows open that are each loaded with different web pages within the overall site, or may be simultaneously performing some actions on their phone while navigating the website on their computer. An example is the user being on the phone with an agent of the merchant while simultaneously navigating the merchant's website on their computer. The omni-channel 380 detects these interactions and notifies the ambient awareness layer 350 accordingly. As with the other notifications, the ambient awareness layer 350 determines the relevance of the provided information to the different web modules 320 and provides notifications to those web modules 320 and/or the web manager 315 interested in the information.

FIG. 4 illustrates a block diagram of an exemplary ambient awareness system 400, according to some embodiments. As shown in FIG. 4, the ambient awareness system 400 includes an I/O interface 410, a subscription processing unit 420, event reception unit 430, a memory 435, an event processing unit 440, and a messaging unit 450, and may represent an exemplary embodiment of ambient awareness layer 350.

The I/O interface 410 receives event notifications from the various web modules 320 and external modules 360-380. In an embodiment, the I/O interface 410 communicates using any suitable wired or wireless communication standard. In an embodiment, the event notification messages include one or more bits to identify the module from which the message originated and a plurality of bits pertaining to the detected event. In an embodiment, the events are encoded according to a lookup table. The I/O interface 410 is also responsible for transmitting notification messages to the various web modules 320, as will be described in further detail below.

In an embodiment, the ambient awareness system 400 performs event notifications using a subscription/publication configuration. In other words, a web module 320 can subscribe to receive only certain notifications. These notifications may be ones pertaining to a specific type of event, or one from specific types of modules. In order to subscribe to the ambient awareness service, a web module 320 transmits a subscription request to the ambient awareness system 400. The request is received by the I/O interface 410 and passed to the subscription processing unit 420. The subscription processing unit 420 receives the request and parses the necessary information. For example, the subscription processing unit 420 may identify the web module 320 from which the request originated, as well as the events for which notifications are requested. For example, in an embodiment, the notifications being requested can be for specific types of notifications, notifications regarding activities from specific types of modules 320, 360-380, or notifications from specific modules 320, 360-380. The subscription processing unit 420 parses this information from the received request message and stores the resulting subscription information in the memory 435.

During subsequent operation, a web module 320 or external module 360-380 may detect certain activity that triggers their event notification. These events may vary and may differ for each different module 320, 360-380. Some examples may include the user mousing over a particular region within a web GUI, clicking on certain items within the web GUI, entering text into a form field of the web GUI, etc. When an event occurs at a particular web GUI corresponding to a web module 320, the web module 320 transmits an event notification to the ambient awareness system 400. The ambient awareness system 400 receives the event notification message via the I/O interface 410 and forwards it to the event processing unit 440.

The event reception unit 430 receives the event notification message and parses the contents of the message in order to identify several different components of the message. For example, the event processing unit 440 identifies, from the event notification message, including for example originating module and type of event. In an embodiment, this information is stored in the memory. In other embodiments, this information is provided directly to the event processing unit 440.

The event processing unit 440 receives the parsed information from the event reception unit 430 or from the memory 435. The event processing unit 440 then determines which of the other web modules have subscribed to the particular event that occurred. For example, the event processing unit 440 first identifies the originating web module 320 at which the event occurred, and excludes it from the analysis. The event processing unit 440 then accesses the memory 435, and identifies the subscribers that have subscribed to any aspect of the event. For example, some web modules 320 may be subscribed to the particular type of event, some may be subscribed to the module 320, 360-380 in which the event occurred, and others may be subscribed to all events. Each of these web modules 320 are identified by the event processing unit 440. The event processing unit 440 then notifies the messaging unit 450 as to the subscribed web modules 320.

The messaging unit 450 generates the notification message to be sent to the subscribing modules 320 identified by the event processing unit 440. In an embodiment, the notification message identifies the module 320, 360-380 in which the event occurred, the type of event that occurred, and/or a description of the specific event that occurred. The message is then forwarded to the I/O interface 410, which transmits the message to the various subscribing modules 320. In an embodiment, separate messages are generated for each of the subscribing modules 320.

The ambient awareness system 400 operates in similar fashion for events received from external modules 360-380. As they can with regard to module events, the web modules 320 can also subscribe to certain external events or sources. For example, a web module 320 can subscribe to all geographic-based events triggered by the AI 360, or to all events triggered by the AI 360. Similar subscriptions can be made with respect to the server status 370 and the omni-channel 380. Thus, when the ambient awareness system 400 receives an event notification from one of the external sources 360-380, the event processing unit 440 identifies the modules 320 that have subscribed to those particular events based on the subscription data stored in the memory 435, and causes the messaging unit 450 and I/O interface 410 to transmit notification messages to those web modules 320 that have subscribed.

Once the notification messages have been transmitted to the subscribing web modules 320, those web modules 320 can then modify their behavior, web GUI appearance, and/or functionality according to their programmed response to the particular event being messages. For example, a notification that the user clicked on their primary credit card may cause an account module 320 to display recent transactions on that card, or a notification that the server is experiencing high load may cause a module 320 to render output on the user's device rather than at the server. A variety of responsive actions may be taken in the different modules based on the different events that were reported. In this manner, the website becomes more personalized and responsive to the user's actions and apparent needs.

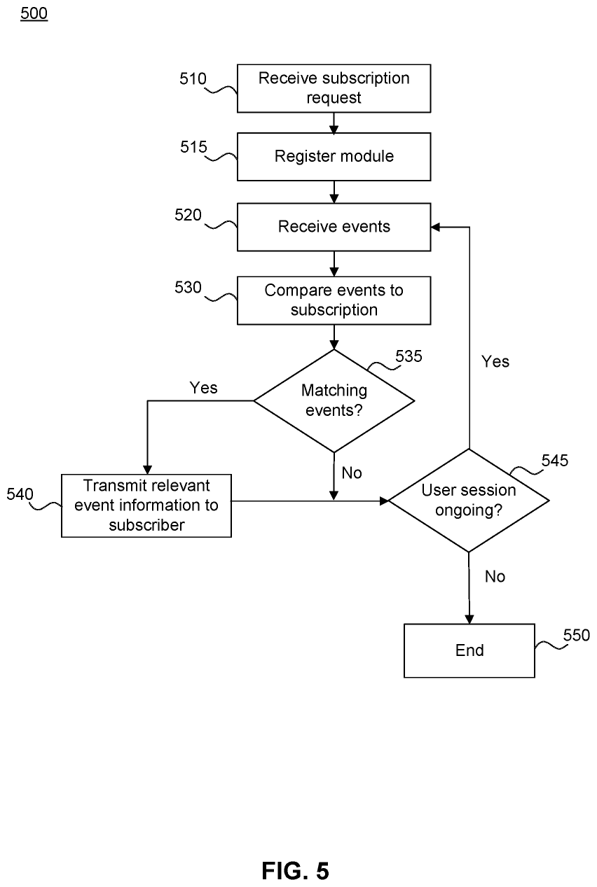

FIG. 5 illustrates a flowchart diagram of an exemplary method 500 for ambient awareness, according to some embodiments.

As shown in FIG. 5, the method 500 begins at step 510 where the ambient awareness system receives a subscription request from a module. In an embodiment, the subscription request includes an identification of the web module 320 from which the request originated, as well as the event types/events for which notifications are requested.

In step 515, the ambient awareness system registers the module by storing the events/event types for which notifications are requested in association with the module identification in a memory.

In step 520, the ambient awareness system receives an event notification from another module. In embodiments, the event notification may originate from another web module, or from an external module. The ambient awareness system parses the received notification in order to identify the originating module as well as the event being notified.

In step 530, the ambient awareness system searches the memory (e.g., database) for subscribing web modules whose subscription includes events of the received type. For example, some modules may be subscribed to the particular type of event, some may be subscribed to the module in which the event occurred, and others may be subscribed to all events. The ambient awareness system identifies all relevant subscribing modules based on this search.

Therefore, as the ambient awareness system searches the memory, the ambient awareness system determines whether the received event matches any of the subscription criteria of the subscribing modules to determine whether there are any matches in step 535. If there are matches between the received event and the subscription criteria (535-Yes), then the method proceeds to step 540, wherein the ambient awareness system transmits a notification message to the identified subscribing modules. In an embodiment, the notification message identifies the module in which the event occurred, the type of event that occurred, and/or a description of the specific event that occurred.

Once the message has been sent in step 540, or if there are no matching events to subscription criteria (535-No), the method proceeds to step 545. In step 545, a determination is made regarding whether the user session is ongoing. If the user session is ongoing (545-Yes), then the method returns to step 520 to receive additional event notifications. If, on the other hand, the user session has ended (545-No), then the method ends in step 550.

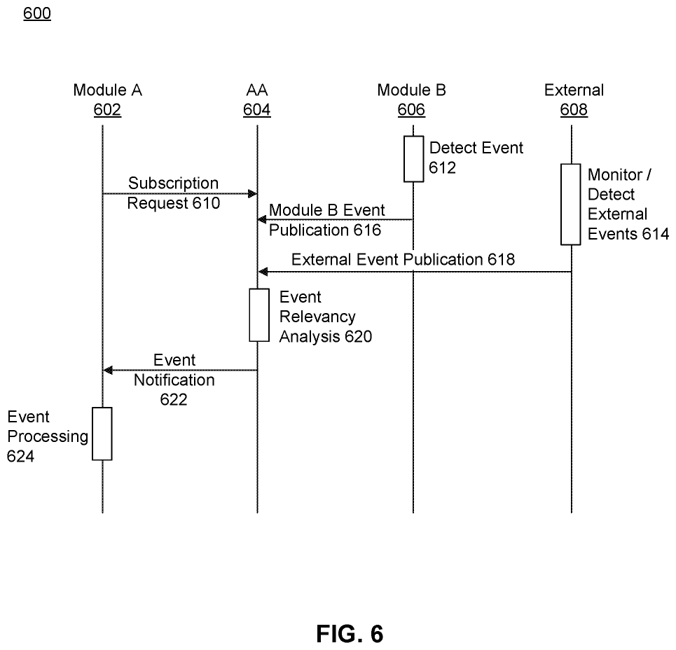

FIG. 6 illustrates a process flow diagram of an exemplary process 600 for ambient awareness, according to some embodiments. As shown in FIG. 6, the example process depicted is between a first web module (e.g., module A 602), the ambient awareness system (e.g., AA 604), a second web module (e.g., module B 606), and an external source (e.g., external 608). Module A 602 and/or module B 606 may be web modules 320, as described with reference to FIG. 3.

As shown in FIG. 6, the process begins by module A 602 transmitting a subscription request 610 to the ambient awareness system 604. In an embodiment, the subscription request includes an identification of the types of events of which module A 602 wants to be notified. The ambient awareness system 604 registers this information in memory.

At some later time, module B 606 detects an event 612. As discussed above, this event may include, but is not limited to, various mouse-over, click on, or search actions performed by the user within module B 606. Module B, in response to detecting the event, transmits an event publication message 616 to the ambient awareness system 604. In an embodiment, the event publication message corresponds to the event notification message discussed above, and includes a description of the event that occurred at module B 606.

While module B is monitoring and detecting events, the external source 608 is also monitoring events at 614. When the external source 608 detects an event at 614, the external source 608 transmits an external event publication message 618 to the ambient awareness system 604. In an embodiment, the external event publication message 618 corresponds to the notification message described above, and includes a description of the event that occurred at the external source 608.

When the ambient awareness system 604 receives the event publication message, whether from module B 606 or from the external source 608, the ambient awareness system 604 performs an event relevancy analysis 620. In an embodiment, this analysis corresponds to the matching analysis described above with respect to FIG. 5, and includes searching the subscription information stored in the memory for any subscribing modules that have requested notifications of events matching at least one characteristic of the received event.

Based on this analysis, if the ambient awareness system 604 finds that one of the received events matches the criteria of those requested by module A, the ambient awareness layer transmits an event notification message 622 to module A 602. Upon receipt, module A performs event processing 624 on the received event, which may include modifying its behavior and/or appearance in response to the event. The process substantially repeats in this fashion until the user's session ends.

It should be understood that unless a method step relies on an earlier method step for completion, the order of the various method steps may be rearranged according to different embodiments and implementations. Additionally, there may be many modifications available for the methods of FIGS. 5 and 6. For example, the methods may further includes the various notified modules modifying their behavior and/or appearance in response to the received notifications.

Various embodiments may be implemented, for example, using one or more well-known computer systems, such as computer system 700 shown in FIG. 7. One or more computer systems 700 may be used, for example, to implement any of the embodiments discussed herein, as well as combinations and sub-combinations thereof.

Computer system 700 may include one or more processors (also called central processing units, or CPUs), such as a processor 704. Processor 704 may be connected to a communication infrastructure or bus 706.

Computer system 700 may also include user input/output device(s) 703, such as monitors, keyboards, pointing devices, etc., which may communicate with communication infrastructure 706 through user input/output interface(s) 702.

One or more of processors 704 may be a graphics processing unit (GPU). In an embodiment, a GPU may be a processor that is a specialized electronic circuit designed to process mathematically intensive applications. The GPU may have a parallel structure that is efficient for parallel processing of large blocks of data, such as mathematically intensive data common to computer graphics applications, images, videos, etc.

Computer system 700 may also include a main or primary memory 708, such as random access memory (RAM). Main memory 708 may include one or more levels of cache. Main memory 708 may have stored therein control logic (i.e., computer software) and/or data.

Computer system 700 may also include one or more secondary storage devices or memory 710. Secondary memory 710 may include, for example, a hard disk drive 712 and/or a removable storage device or drive 714. Removable storage drive 714 may be a floppy disk drive, a magnetic tape drive, a compact disk drive, an optical storage device, tape backup device, and/or any other storage device/drive.

Removable storage drive 714 may interact with a removable storage unit 718. Removable storage unit 718 may include a computer usable or readable storage device having stored thereon computer software (control logic) and/or data. Removable storage unit 718 may be a floppy disk, magnetic tape, compact disk, DVD, optical storage disk, and/any other computer data storage device. Removable storage drive 714 may read from and/or write to removable storage unit 718.

Secondary memory 710 may include other means, devices, components, instrumentalities or other approaches for allowing computer programs and/or other instructions and/or data to be accessed by computer system 700. Such means, devices, components, instrumentalities or other approaches may include, for example, a removable storage unit 722 and an interface 720. Examples of the removable storage unit 722 and the interface 720 may include a program cartridge and cartridge interface (such as that found in video game devices), a removable memory chip (such as an EPROM or PROM) and associated socket, a memory stick and USB port, a memory card and associated memory card slot, and/or any other removable storage unit and associated interface.

Computer system 700 may further include a communication or network interface 724. Communication interface 724 may enable computer system 700 to communicate and interact with any combination of external devices, external networks, external entities, etc. (individually and collectively referenced by reference number 728). For example, communication interface 724 may allow computer system 700 to communicate with external or remote devices 728 over communications path 726, which may be wired and/or wireless (or a combination thereof), and which may include any combination of LANs, WANs, the Internet, etc. Control logic and/or data may be transmitted to and from computer system 700 via communication path 726.

Computer system 700 may also be any of a personal digital assistant (PDA), desktop workstation, laptop or notebook computer, netbook, tablet, smart phone, smart watch or other wearable, appliance, part of the Internet-of-Things, and/or embedded system, to name a few non-limiting examples, or any combination thereof.

Computer system 700 may be a client or server, accessing or hosting any applications and/or data through any delivery paradigm, including but not limited to remote or distributed cloud computing solutions; local or on-premises software (“on-premise” cloud-based solutions); “as a service” models (e.g., content as a service (CaaS), digital content as a service (DCaaS), software as a service (SaaS), managed software as a service (MSaaS), platform as a service (PaaS), desktop as a service (DaaS), framework as a service (FaaS), backend as a service (BaaS), mobile backend as a service (MBaaS), infrastructure as a service (IaaS), etc.); and/or a hybrid model including any combination of the foregoing examples or other services or delivery paradigms.

Any applicable data structures, file formats, and schemas in computer system 700 may be derived from standards including but not limited to JavaScript Object Notation (JSON), Extensible Markup Language (XML), Yet Another Markup Language (YAML), Extensible Hypertext Markup Language (XHTML), Wireless Markup Language (WML), MessagePack, XML User Interface Language (XUL), or any other functionally similar representations alone or in combination. Alternatively, proprietary data structures, formats or schemas may be used, either exclusively or in combination with known or open standards.

In some embodiments, a tangible, non-transitory apparatus or article of manufacture comprising a tangible, non-transitory computer useable or readable medium having control logic (software) stored thereon may also be referred to herein as a computer program product or program storage device. This includes, but is not limited to, computer system 700, main memory 708, secondary memory 710, and removable storage units 718 and 722, as well as tangible articles of manufacture embodying any combination of the foregoing. Such control logic, when executed by one or more data processing devices (such as computer system 700), may cause such data processing devices to operate as described herein.

Based on the teachings contained in this disclosure, it will be apparent to persons skilled in the relevant art(s) how to make and use embodiments of this disclosure using data processing devices, computer systems and/or computer architectures other than that shown in FIG. 7. In particular, embodiments can operate with software, hardware, and/or operating system implementations other than those described herein.

It is to be appreciated that the Detailed Description section, and not any other section, is intended to be used to interpret the claims. Other sections can set forth one or more but not all exemplary embodiments as contemplated by the inventor(s), and thus, are not intended to limit this disclosure or the appended claims in any way.

While this disclosure describes exemplary embodiments for exemplary fields and applications, it should be understood that the disclosure is not limited thereto. Other embodiments and modifications thereto are possible, and are within the scope and spirit of this disclosure. For example, and without limiting the generality of this paragraph, embodiments are not limited to the software, hardware, firmware, and/or entities illustrated in the figures and/or described herein. Further, embodiments (whether or not explicitly described herein) have significant utility to fields and applications beyond the examples described herein.

Embodiments have been described herein with the aid of functional building blocks illustrating the implementation of specified functions and relationships thereof. The boundaries of these functional building blocks have been arbitrarily defined herein for the convenience of the description. Alternate boundaries can be defined as long as the specified functions and relationships (or equivalents thereof) are appropriately performed. Also, alternative embodiments can perform functional blocks, steps, operations, methods, etc. using orderings different than those described herein.

References herein to “one embodiment,” “an embodiment,” “an example embodiment,” or similar phrases, indicate that the embodiment described can include a particular feature, structure, or characteristic, but every embodiment can not necessarily include the particular feature, structure, or characteristic. Moreover, such phrases are not necessarily referring to the same embodiment. Further, when a particular feature, structure, or characteristic is described in connection with an embodiment, it would be within the knowledge of persons skilled in the relevant art(s) to incorporate such feature, structure, or characteristic into other embodiments whether or not explicitly mentioned or described herein. Additionally, some embodiments can be described using the expression “coupled” and “connected” along with their derivatives. These terms are not necessarily intended as synonyms for each other. For example, some embodiments can be described using the terms “connected” and/or “coupled” to indicate that two or more elements are in direct physical or electrical contact with each other. The term “coupled,” however, can also mean that two or more elements are not in direct contact with each other, but yet still co-operate or interact with each other.

The breadth and scope of this disclosure should not be limited by any of the above-described exemplary embodiments, but should be defined only in accordance with the following claims and their equivalents.

What is claimed is:

1. A ambient awareness system, comprising:
a first web application, executed by one or more processors, configured to detect an action by a user with respect to a first graphical user interface (GUI) generated by the first web application, and to transmit an event publication in response to the detecting;
an ambient awareness layer, executed by the one or more processors, configured to:
receive the event publication from the first web application;
identify a second web application to be notified of the detected event; and
transmit an event notification to the second web application; and
the second web application, executed by the one or more processors, configured to:
receive the event notification from the ambient awareness layer; and
modify an appearance of a second GUI generated by the second web application based on the received event notification.

2. The ambient awareness system of claim 1, wherein the first GUI and the second GUI constitute portions of a website or a web interface.

3. The ambient awareness system of claim 1, wherein the ambient awareness layer is further configured to receive an event publication from an external source.

4. The ambient awareness system of claim 3, wherein the external source includes at least one of an artificial intelligence subsystem, a server status subsystem, or an omni-channel subsystem.

5. The ambient awareness system of claim 1, wherein the ambient awareness layer is further configured to:
receive an event publication from a server status subsystem that indicates that a server is experiencing a high load; and
transmit a notification message to the second web application in response to the event publication, wherein the second web application is configured to modify its behavior by rendering output calculations at a user device rather than at the server, in response to the notification message.

6. The ambient awareness system of claim 1, wherein the second web application is configured to modify the appearance of the second GUI by displaying or emphasizing certain information, or by highlighting or emphasizing the second GUI.

7. The ambient awareness system of claim 1, wherein the second web application is a webpage manager configured to modify a layout of the webpage and/or enable or disable web applications in response to the event notification.

8. An ambient awareness device, comprising:
a communication interface configured to send and receive electronic communications;
a memory that stores event subscriptions of a web application included within a webpage; and
one or more processors configured to:
receive an event publication from a first web application, the event publication indicating a user action with respect to a graphical user interface generated by the first web application;
query the event subscriptions stored in the memory for a second web application to be notified of the detected event; and
transmit an event notification to the second web application that informs the second web application of the user action.

9. The ambient awareness device of claim 8, wherein the event notification includes an identification of the first web application in which the user action occurred.

10. The ambient awareness device of claim 8, wherein the event notification causes a modification of behavior or appearance in the second web application.

11. The ambient awareness device of claim 8, wherein the one or more processors are further configured to receive an event publication from an external source.

12. The ambient awareness device of claim 11, wherein the external source includes at least one of an artificial intelligence subsystem, a server status subsystem, or an omni-channel subsystem.

13. The ambient awareness device of claim 8, wherein the one or more processors are further configured to transmit an event notification to a webpage manager responsible for managing a layout and/or appearance of the webpage.

14. The ambient awareness device of claim 8, wherein the one or more processors are configured to:
receive a subscription request from the second web application that indicates one or more event properties; and
store the event properties in the memory in association with the second web application.

15. A method comprising:
storing event subscriptions of web applications included within a webpage in a memory;
receiving an event publication from a first web application, the event publication indicating a user action with respect to a graphical user interface generated by the first web application;
querying the event subscriptions stored in the memory for a second web application to be notified of the detected event; and
transmitting an event notification to the second web application that informs the second web application of the user action.

16. The method of claim 15, wherein the event notification includes an identification of the first web application in which the user action occurred.

17. The method of claim 15, wherein the event notification causes a modification of behavior or appearance in the second web application.

18. The method of claim 15, further comprising receiving an event publication from an external source, the external source including at least one of an artificial intelligence subsystem, a server status subsystem, or an omni-channel subsystem.

19. The method of claim 15, further comprising transmitting an event notification to a webpage manager responsible for managing a layout and/or appearance of the webpage.

20. The method of claim 15, further comprising:
receiving a subscription request from the second web application that indicates one or more event properties; and
storing the event properties in the memory in association with the second web application.
